(19) United States
(12) Patent Application Publication
(10) Pub. No.: US 2017/0074397 A1
(43) Pub. Date: Mar. 16, 2017

(54) METHOD FOR CONTROLLING GEAR ACTUATOR FOR VEHICLES

(71) Applicants: Hyundai Motor Company, Seoul (KR); Kia Motors Corporation, Seoul (KR)

(72) Inventor: Young Min Yoon, Suwon-si (KR)

(73) Assignees: Hyundai Motor Company, Seoul (KR); Kia Motors Corporation, Seoul (KR)

(21) Appl. No.: 14/946,351

(22) Filed: Nov. 19, 2015

(30) Foreign Application Priority Data
Sep. 15, 2015 (KR) 10-2015-0130528

(51) Int. Cl. F16H 63/20; F16H 61/12

(52) U.S. Cl. CPC F16H 63/20; F16H 61/12; F16H 2061/1288; F16H 2063/208

(57) ABSTRACT

A method for controlling a vehicle gear actuator is capable of quickly and simply measuring the reference point of a shift finger. The method for controlling includes a determination step in which whether gear shifting is necessary is determined; a check step in which the first end of a shifting path is checked by moving a shift finger to the first end before moving the shift finger to the second end of the shifting path to engage a corresponding gear when gear shifting is necessary; and a concurrent control step in which the reference point of the gear actuator is learned by acquiring a full stroke of the shift finger simultaneously with engaging the corresponding gear by moving the shift finger to the second end of the shifting path after the check step.

### CROSS-REFERENCE TO RELATED APPLICATIONS

The present application claims the benefit of Korean Patent Application No. 10-2015-0130528, filed Sep. 15, 2015, the contents of which are incorporated herein by this reference in its entirety.

### FIELD

The present disclosure generally relates to a method for controlling a vehicle gear actuator.

### BACKGROUND

The statements in this section merely provide background information related to the present disclosure and may not constitute prior art.

An automated manual transmission, which may achieve both driving convenience of an automatic transmission and high fuel efficiency and power efficiency of a manual transmission, is actively being used in currently manufactured vehicles.

The automated manual transmission is a system that automatically controls a clutch operation and gear shifting based on a manual transmission mechanism having a clutch, and such gear shifting is controlled using an actuator, which is driven by oil pressure or a motor.

Particularly, for accurate gear shifting, a position sensor is required to measure the current position of a shift finger (control finger) that serves to engage and disengage a gear, but the position sensor may raise the cost of a product, and may cause concerns in terms of package configuration and the weight.

Also, when an ignition is turned on in a vehicle and power is applied to a Transmission Control Unit (TCU) for controlling the actuator, the actuator starts to operate and the initial position of the shift finger is initialized to ‘0’ regardless of the current position thereof. Furthermore, if acquisition of the reference point fails during the operation, because the currently known reference position may not be identical to the current position, there may be an issue in acquiring an accurate reference point.

### SUMMARY

The present disclosure provides a method for controlling a vehicle gear actuator that is capable of quickly and simply measuring the reference position of a shift finger without use of a position sensor.

According to one form of the present disclosure, there is provided a method for controlling a vehicle gear actuator, including: a determination operation in which whether gear shifting is necessary is determined; a check operation in which a first end of a shifting path is checked by moving a shift finger to the first end before moving the shift finger to a second end of the shifting path to engage a corresponding gear when gear shifting is necessary; and a concurrent control operation in which a reference point of the gear actuator is learned by acquiring a full stroke of the shift finger simultaneously with engaging the corresponding gear by moving the shift finger to the second end of the shifting path after the check operation.

The determination operation may determine that gear shifting is necessary when an engine is cranked.

The determination operation may be configured to start the check operation when a failure signal of the gear actuator is detected during upshifting or downshifting.

The concurrent control operation may be configured to calculate a center point of a distance from the first end to the second end of the shifting path and to learn the center point as the reference point of the gear actuator.

The present disclosure may be configured to include: a determination operation by a control unit in which whether gear shifting is necessary is determined; a check operation in which a first end of a shifting path is checked by enabling the gear actuator to move a shift finger to the first end before the shift finger is moved to a second end of the shifting path to engage a corresponding gear when gear shifting is necessary; and a concurrent control operation in which a reference point of the gear actuator is learned by acquiring a full stroke of the shift finger by the control unit simultaneously with engagement of the corresponding gear by enabling the gear actuator to move the shift finger to the second end of the shifting path after the check operation.

As described above, according to the present disclosure, when the operation of a gear actuator is reset, when the acquisition of the reference position of a shift finger fails during the operation of the gear actuator or when the failure of the gear actuator is predicted, the reference position of the shift finger may be simply and quickly acquired without an additional position sensor, whereby the shift control of the gear actuator may be performed more precisely and actively.

Also, when an engine is cranked, because the reference point of the gear actuator is learned simultaneously with the completion of engaging a predetermined target gear, the operation of the gear is completed when the engine reaches a top speed. Accordingly, the gear operating noise is muted by the engine noise, thus reducing the noise from the operation of the gear actuator.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a concept diagram of gear shifting by the operation of a gear actuator;

FIG. 2 is a flowchart illustrating a method for controlling a gear actuator according to the present disclosure;

FIG. 3 illustrates a process in which the reference position of a shift finger is acquired through a gear actuator control method according to the present disclosure; and

FIG. 4 is a graph showing the relationship between the learning operation for a gear actuator reference point and the engine speed according to the principles of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

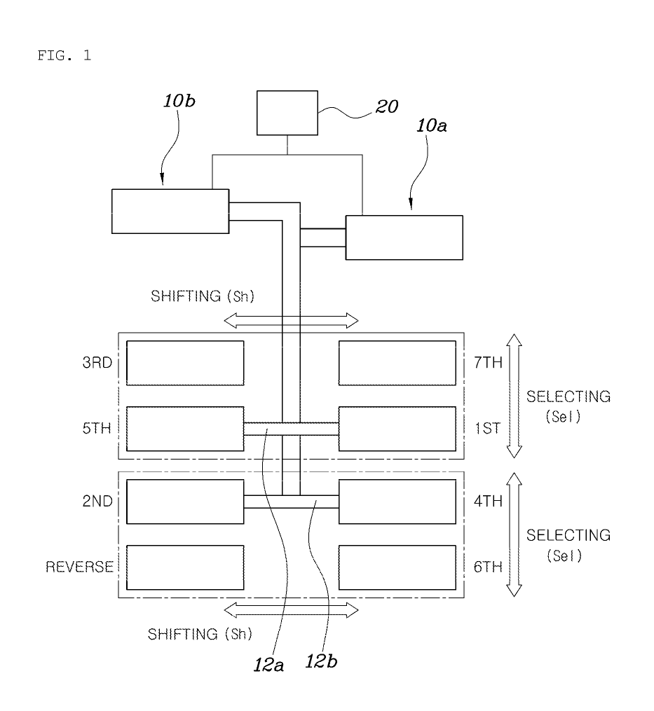

The present disclosure may be applied to a seven-speed dual-clutch transmission. Referring to FIG. 1, a gear actuator 10a for odd-numbered gears may be arranged to operate a shift finger 12a to move along a shifting path Sh and a selecting path Sel for engaging odd-numbered gears including 1st, 3rd, 5th, and 7th gears. Also, a gear actuator 10b for even-numbered gears may be arranged to operate a shift finger 12b to move along a shifting path Sh and a selecting path Sel for engaging even-numbered gears including 2nd, 4th, 6th, and Reverse gears.

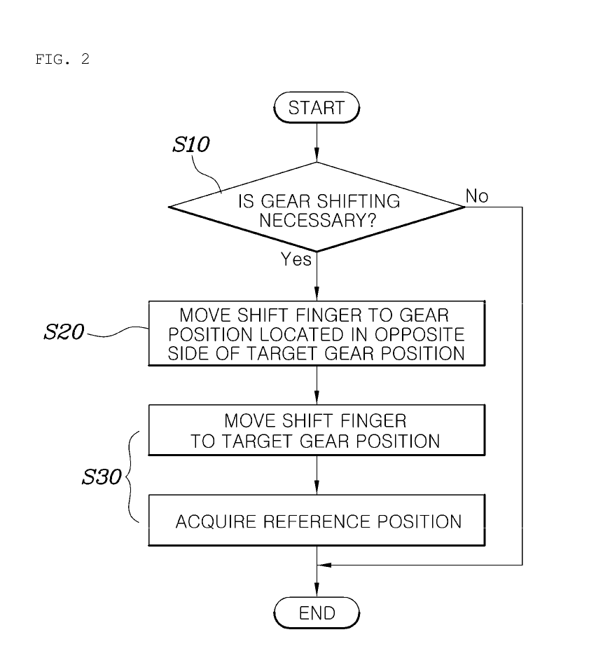

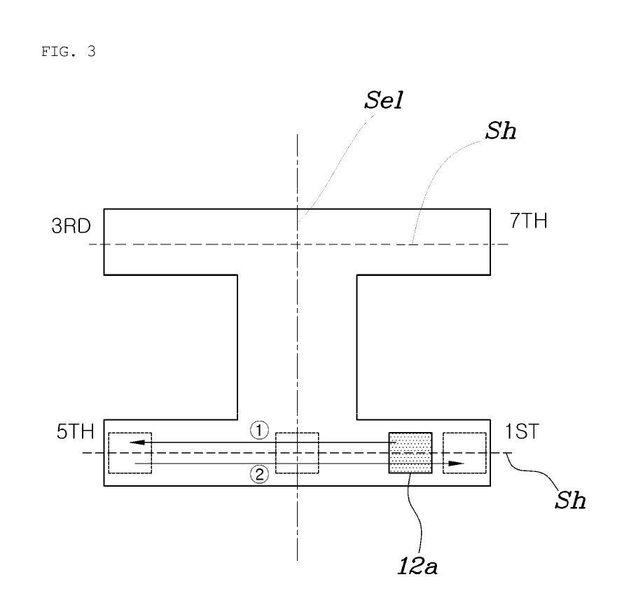

However, FIG. 3 illustrates only one shift finger 12a for clarity of description, and the structures of the shifting path Sh and selecting path Sel and the number of the shift fingers may vary depending on the design variables of the transmission. Referring to FIG. 2, a method for controlling a vehicle gear actuator may be configured to include a determination step S10, a check step S20, and a concurrent control step S30.

First, whether gear shifting is necessary may be determined at the determination step (S10).

For example, the determination step (S10) determines that gear shifting is necessary when an engine is cranked.

When a vehicle is started, the gear actuator 10a for odd-numbered gears and the gear actuator 10b for even-numbered gears move the shift fingers 12a and 12b so as to engage a predetermined odd-numbered gear and a predetermined even-numbered gear, whereby the reference points of the shift fingers 12a and 12b may be learned simultaneously with the engagement of the gear.

Also, the determination step (S10) may control to start the check step (S20) when a failure signal of the gear actuator is detected during upshifting or downshifting.

Specifically, whether the electrical signals of a motor, configuring the vehicle actuator, are normally input and output may be diagnosed through a hall IC (integrated circuit). Accordingly, when the disconnection of a wire, an abnormal sequence pattern of the signal, and the like are detected through the hall IC, the failure of the gear actuator may be predicted. Therefore, when the failure of the gear actuator is predicted, the reference point of the shift finger is checked during upshifting or downshifting of the transmission, whereby the reliability of the operation of the shift finger may be improved.

Additionally, at the check step (S20), if gear shifting is necessary, before the shift finger is moved to one end of the shifting path Sh to engage a corresponding gear, the shift finger is moved to the opposite end of the shifting path Sh in order to check the opposite end of the shifting path Sh.

For example, as shown in FIG. 3, when gear shifting into the first gear is necessary, the shift finger 12a is moved to the position of the fifth gear in the left side before being moved to the position of the first gear in the right side. Accordingly, it is possible to acquire one end position of the shifting path Sh for engaging the first and fifth gears.

Next, at the concurrent control step (S30), the full stroke of the shift finger is acquired simultaneously with the engagement of a corresponding gear by moving the shift finger to one end of the shifting path, which is the position for engaging the corresponding gear, after the check step (S20), whereby the reference point of the gear actuator may be learned.

For example, the center point of the distance from one end to the opposite end of the shifting path Sh is calculated, and the center point may be learned as the reference point of the gear actuator.

In other words, as described above, if the shift finger 12a, which has moved to the fifth gear position, is moved to the first gear position, the position of one end of the corresponding shifting path Sh, which is the fifth gear position, may be checked. As a result, the full stroke of the shift finger 12a, which moves along the shifting path Sh, may be acquired. Then, the point corresponding to ½ of the full stroke may be calculated, and the calculated point may be confirmed as the reference point of the shift finger 12a, operated by the gear actuator.

Although the shift finger 12a operated by the gear actuator 10a for odd-numbered gears is described above, the shift finger operated by the gear actuator 10b for even-numbered gears may be operated by the same method. Particularly, when an engine is cranked, as the gear actuator 10a for odd-numbered gears and the gear actuator 10b for even-numbered gears 10b are operated at the same time, the reference point of the shift finger 12a of the odd-numbered gears and the reference point of the shift finger 12b of the even-numbered gears may be learned simultaneously.

Hereinafter, referring to FIG. 2, the control flow of the gear actuator according to the present disclosure will be described.

First, whether gear shifting is necessary is determined by a control unit 20.

When it is determined that gear shifting is necessary, the shift finger 12a is moved using a gear actuator, which is used for engaging a corresponding gear. In this case, the shift finger 12a is moved to the gear position located in the opposite side of a target gear position.

Subsequently, the shift finger 12a is moved to the target gear position using the gear actuator 10a.

Therefore, the full stroke of the shift finger 12a, which moves along the shifting path Sh, may be checked simultaneously with engagement of the target gear, and the reference point of the corresponding gear actuator 10a may be acquired.

As described above, according to the present disclosure, when the operation of a gear actuator is reset, when acquisition of the reference position of a shift finger fails during the operation of the gear actuator, or when the failure of the gear actuator is predicted, the reference position of a shift finger may be simply and quickly acquired without an additional position sensor, whereby the shift control of the gear actuator may be performed more precisely and actively.

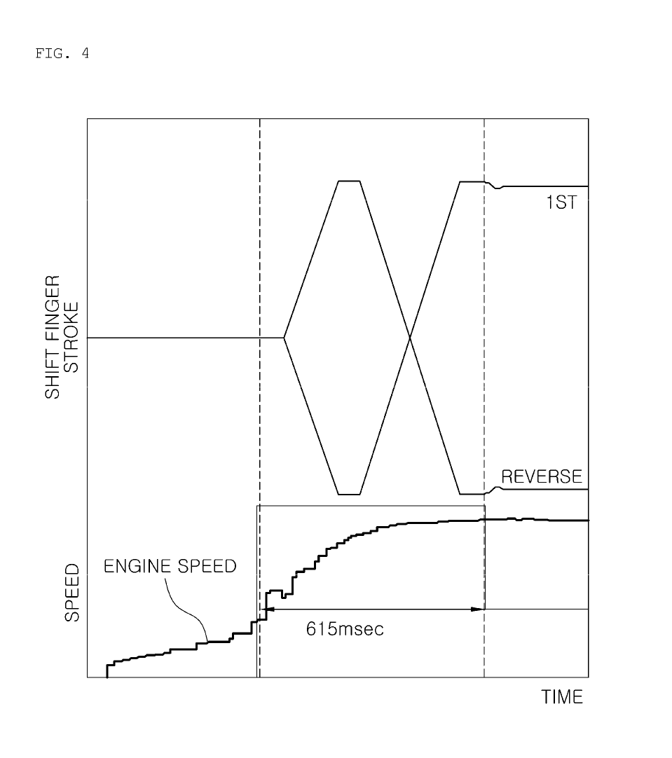

Also, when an engine is cranked, because the reference point of a gear actuator is learned simultaneously with the completion of engaging a predetermined target gear, the operation of the gear is completed when the engine reaches the maximum speed as shown in FIG. 4. Accordingly, the gear operating noise is muted by the engine noise, thus reducing the noise from the operation of the gear actuator. The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for controlling a vehicle gear actuator comprising:
a determination operation in which whether gear shifting is necessary is determined;
a check operation in which a first end of a shifting path is checked by moving a shift finger to the first end before moving the shift finger to a second end of the shifting path to engage a corresponding gear when gear shifting is necessary; and
a concurrent control operation in which a reference point of the gear actuator is learned by acquiring a full stroke of the shift finger simultaneously with engaging the corresponding gear by moving the shift finger to the second end of the shifting path after the check operation.

2. The method of claim 1, wherein the determination operation determines that gear shifting is necessary when an engine is cranked.

3. The method of claim 1, wherein the determination operation is configured to start the check operation when a failure signal of the gear actuator is detected during upshifting or downshifting.

4. The method of claim 1, wherein the concurrent control operation is configured to calculate a center point of a distance from the first end to the second end of the shifting path and to learn the center point as the reference point of the gear actuator.

5. A method for controlling a vehicle gear actuator comprising:
a determination operation by a control unit in which whether gear shifting is necessary is determined;
a check operation in which a first end of a shifting path is checked by enabling the gear actuator to move a shift finger to the first end before the shift finger is moved to a second end of the shifting path to engage a corresponding gear when gear shifting is necessary; and
a concurrent control operation in which a reference point of the gear actuator is learned by acquiring a full stroke of the shift finger by the control unit simultaneously with engagement of the corresponding gear by enabling the gear actuator to move the shift finger to the second end of the shifting path after the check operation.
